(19) United States
(12) Patent Application Publication
(10) Pub. No.: US 2001/0010690 A1
(43) Pub. Date: Aug. 2, 2001

(54) Method, service switching point, service control point, internet gateway, program module, and internet terminal for establishing a connection between a telephone-network terminal and an internet terminal

(76) Inventor: Yuzhong Shen, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/748,286

(22) Filed: Dec. 27, 2000

(30) Foreign Application Priority Data
Jan. 13, 2000 (DE) 100 01 077.6

(51) Int. Cl. H04L 12/66

(52) U.S. Cl. 370/352; 370/410

(57) ABSTRACT

The invention relates to a method of establishing a connection between a telephone-network terminal (TELA) and an Internet terminal (TERB) through a telephone network (PSTN) designed as an intelligent network and the Internet (INT), and to a service switching point (SSP), a service control point (SCP), an Internet gateway (GW1), a program module, and an Internet terminal (TERB) for carrying out this method. The telephone network receives from the telephone-network terminal a request for a connection to a subscriber number assigned to the Internet terminal and routes this request to a service switching point (SSP), which then sends a service request message to a service control point (SCP) to request a service for handling the request for the connection to the subscriber number assigned to the Internet terminal. The service control point determines an Internet address of the Internet terminal assigned to the subscriber number and sends this address in a service message to the service switching point. The service switching point sets up a connection to an Internet gateway through the telephone network and sends the Internet address of the Internet terminal to this gateway, whereupon the latter sets up the link (VB1) of the connection between the telephone-network terminal and the Internet terminal through the Internet using the Internet address of the Internet terminal.

### DESCRIPTION

This invention relates to a method as set forth in the preamble of claim 1 and to a service switching point, a service control point, an Internet gateway, a program module, and an Internet terminal for carrying out this method as set forth in the preambles of claims 7, 8, 9, 10, and 11, respectively.

To an increasing extent, not only “classic”, public switched telephone networks (PSTNs), which switch exclusively one line per call, but also packet-based data networks, particularly the Internet, are being used for telephone calls. This form of telephony is also referred to as “Voice over Internet Protocol” (VoIP), and is defined, for example, in Standard H.323 of the ITU (International Telecommunication Union).

Standards or recommendations for Internet telephony that are comparable to the H.323 Standard are also being pursued by the IETF (Internet Engineering Task Force). According to those standards or recommendations, calls between terminals connected to the Internet, generally personal computers, are readily possible by entering the Internet address of the called Internet terminal at the “calling” Internet terminal, thus causing a (logical) connection to be set up between the two Internet terminals through the Internet.

For voice calls or for multimedia communications between the Internet and a telephone network, a so-called gateway, also referred to as a VoIP gateway, provides a bridge function. A connection can then be established from a telephone connected to the telephone network to an Internet terminal. To accomplish this, first a connection is established from the telephone to the VoIP gateway through the telephone network. Then, the Internet address of a desired Internet telephone is sent from the telephone to the VoIP gateway, whereupon the latter sets up the desired connection to the Internet terminal through the Internet. A subscriber who uses the telephone must enter both the number of the VoIP gateway and the Internet address of the Internet terminal. This is very troublesome and inconvenient, if only for the reason that Internet addresses of nonpermanently attached Internet terminals are assigned dynamically and are thus valid for only short periods of time. Furthermore, for the connection between the telephone and the VoIP gateway dialed by the subscriber, high charges may have to be paid, which would be lower if an alternative VoIP gateway were dialed. In addition, the dialed call to the VoIP gateway may place a much heavier load on the telephone network than a dialed call to an alternative VoIP gateway.

It is therefore an object of the invention to enable a user of a telephone-network terminal to establish a connection between the latter and an Internet terminal in a simple and convenient manner.

This object is attained by a method according to the technical teaching of claim 1, by a service switching point according to the technical teaching of claim 7, by a service control point according to the technical teaching of claim 8, by an Internet gateway according to the technical teaching of claim 9, by a program module according to the technical teaching of claim 10, and by an Internet terminal according to the technical teaching of claim 11. Preferred embodiments of the invention are set forth in the dependent claims and the description. Combinations of the features of the claims are readily possible.

The invention is based on the idea that a subscriber enters at his telephone-network terminal only a subscriber number of an Internet terminal of the party to be called. The telephone-network terminal then sends a call request to the telephone network, which is designed as an intelligent network (IN). The telephone network routes the call request to a so-called service switching point (SSP). The service switching point determines that the call request is to be treated as a call request to an intelligent network, and transfers a service request message to a service switching point (SCP). In the service request message, the service switching point requests from the service control point a service for handling the subscriber number specified in the call request. The service control point determines an Internet address of the Internet terminal assigned to the subscriber number, and transfers a service message with the Internet address of the Internet terminal to the service switching point. Then, the service switching point sets up a connection through the telephone network to the Internet gateway via which the connection between the telephone-network terminal and the Internet terminal can be established. The service switching point sends the Internet address of the Internet terminal to the Internet gateway. The link still required for the connection between the telephone-network terminal and the Internet terminal is set up by the Internet gateway through the Internet using the Internet address of the Internet terminal.

Thus, the calling subscriber only needs to know the “virtual” subscriber number of the Internet terminal of the party to be called, and to enter this number at the telephone-network terminal, not the “physical” Internet address of the latter and the number of the gateway. The subscriber number may also be a so-called UPT (Universal Personal Telecommunications) number, at which the called party can always be reached. If, for example, the called party end can currently be reached via a subscriber station of the telephone network, a call directed to the UPT number will be routed by the service control point to this subscriber station. If, however, the called party can currently be reached via the Internet terminal, according to the invention, a call directed to the UPT number will be routed by the service control point to the Internet terminal.

The address of the gateway may be stored in the service switching point for establishing the connection to the gateway, but in one variant of the invention, the service control point sends not only the Internet address of the Internet terminal, but also the address of the gateway. This address may be stored in association with the Internet address of the Internet terminal in a table in the service control point. It is also possible that the service control point determines the address of the gateway based on a loading of communication paths of the telephone network or on charges that are incurred on the telephone network for the establishment of the links of the connection between the telephone-network terminal and the Internet gateway. For these reasons, the service control point can also notify the service switching point of an address of an alternative gateway. Furthermore, the service control point may also transfer a selection of gateway addresses to the service switching point, so that the latter can select a gateway that is optimally suited for the desired connection between the telephone-network terminal and the Internet terminal.

Since, as mentioned above, Internet addresses are commonly assigned dynamically, the gateway or the Internet terminal advantageously informs the service control point directly or via a higher-level Service Management Point (SMP) which Internet address is currently assigned to the Internet terminal.

It is also readily possible within the scope of the invention to use instead of the Internet an intranet or any other form of online data network in which the attached terminal requires an addressing mode different from that in the telephone network and in which a gateway is connected between the telephone network and the data network.

The invention and its advantages will become more apparent from the following description of an embodiment taken in conjunction with the accompanying drawings, in which:

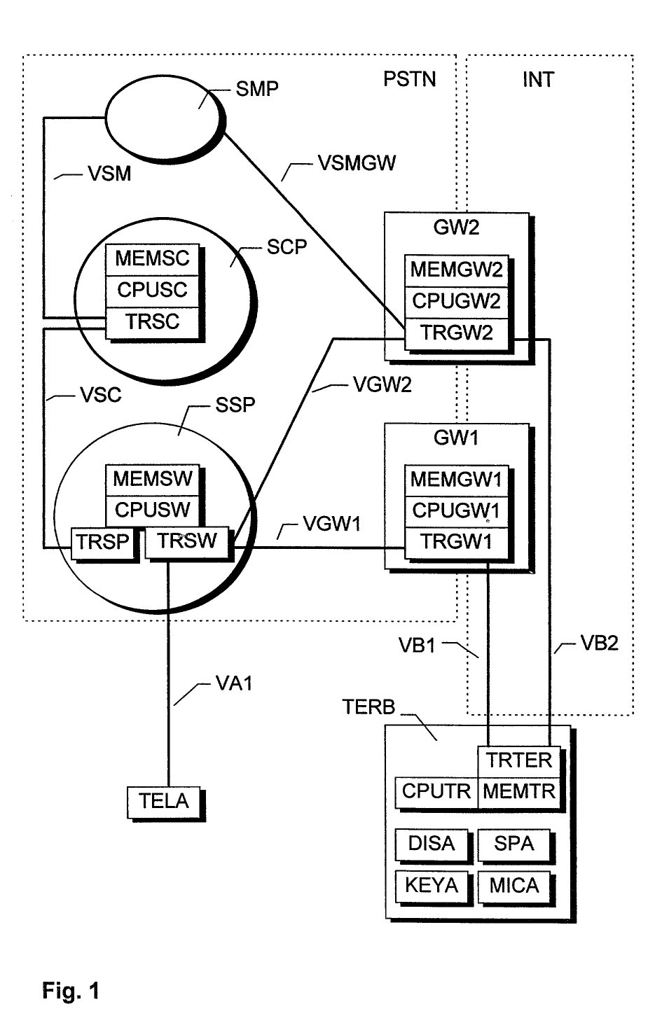

FIG. 1 shows an arrangement for carrying out the method according to the invention, with a telephone-network terminal TELA, an Internet terminal TERB, and one embodiment each of a service switching point SSP according to the invention, a service control point SCP according to the invention, and gateways GW1, GW2 according to the invention;

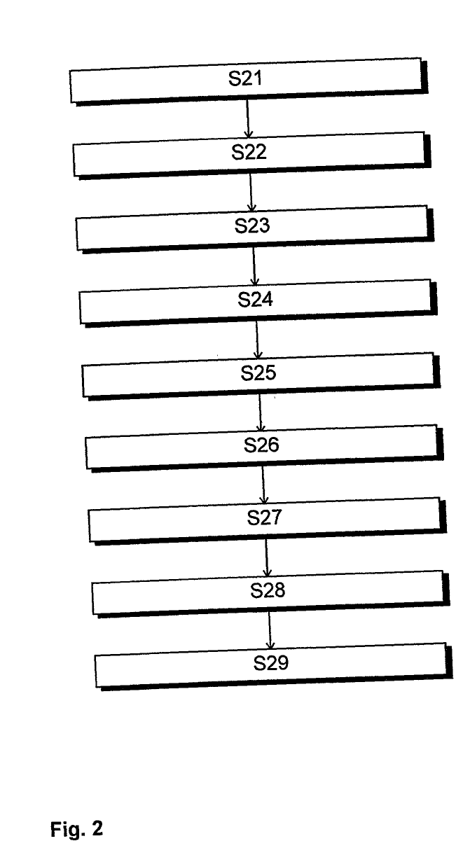

FIG. 2 is a flowchart of the method according to the invention; and

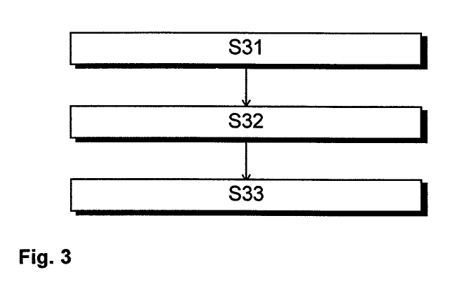

FIG. 3 is a flowchart of a program module according to the invention.

FIG. 1 shows an exemplary arrangement with which the invention can be implemented. A telecommunications network PSTN and the Internet INT are each indicated by a dotted box. Subscribers SUBA and SUBB (not shown) have a telephone-network terminal TELA and an Internet terminal TERB, respectively. Telephone-network terminal TELA is, for example, a wireline telephone, a mobile radiotelephone, or a personal computer equipped for telephony. Telephone-network terminal TELA may be equipped for both voice communication and video communication and for combinations thereof.

Internet terminal TERB is preferably designed for connection to a personal computer equipped for Internet communication but may also be a mobile radio-telephone or wireline telephone suitable for Internet communication, for example. By incorporating suitable software and hardware, Internet terminal TERB is equipped for multimedia communication, particularly for voice and/or video calls. Terminal TERB includes a connection means TRTER, for example a modem or an ISDN adapter. Through connection means TRTER, terminal TERB can establish a connection to the Internet INT; this connection may also be set up in the known manner through telecommunications network PSTN or another telephone network (not shown). Terminal TERB further comprises control means CPUTR and a memory means MEMTR. Control means CPUTR is, for example, a processor with which program code stored in memory means MEMTR can be executed. Memory means MEMTR is a hard disk or consists of RAM modules, for example. Furthermore, terminal TERB comprises a display means DISA and an input means KEYA. Display means DISA is, for instance, a computer monitor or a liquid crystal display (LCD). Input means KEYA may be a keyboard or a mouse. Terminal TERB further comprises a loudspeaker SPA and a microphone MICA for speech output and input, respectively. Using program code stored in memory means MEMTR and executable by control means CPUTR, for example, Internet terminal TERB functions as a terminal for multimedia communication, i.e., also as a terminal for voice communication, for example according to the above-mentioned H.323 Standard of the ITU or according to a standard of the IETF.

Of telecommunications network PSTN, a service switching point SSP, a service control point SCP, and a service management point SMP are shown substitutionally for further equipment (not shown), such as exchanges, front-end equipment, and trunks. Service switching point SSP, service control point SCP, and service management point SMP are elements of an intelligent network. The basic functions of a service switching point, a service control point, and a service management point have been standardized by the ITU and therefore need not be explained here. Further equipment of telecommunications network PSTN, such as intelligent peripherals for voice synthesis, voice recognition, and the like as well as a so-called service creation environment (SCE), is not shown in FIG. 1 for the sake of clarity. Telecommunications network PSTN is designed as an intelligent network.

Service switching point SSP and service control point SCP are connected by a link VSC, and service control point SCP and service management point SMP are connected by a link VSM. Links VSC and VSM are preferably signaling channels or part of a signaling network. Such a signaling network is the Common Channel Signaling System No. 7, for example.

Of service switching point SSP, a few essential components are shown by way of example, namely connection means TRSW and TRSP, a control means CPUSW, and a memory means MEMSW. Through connection means TRSW, service switching point SSP can set up data and voice calls to subscribers or to other service switching points (not shown). Through connection means TRSP, service switching point SSP can set up signaling links, such as the link VSC to service control point SCP. Control means CPUSW is a processor or a group of processors that can execute instructions stored in memory means MEMSW. Control means CPUSW controls the functions of service switching point SSP and in doing so influences the functions of connection means TRSW. Connection means TRSW, control means CPUSW, and memory means MEMSW are interconnected by connections not shown in FIG. 1. Service switching point SSP may comprise further modules, such as a switching network or an interface to a Network Management System. Service switching point SSP may be a local exchange to which the telephone-network terminal TELA and further terminals (not shown) are connected. Service switching point SSP may be preceded by further equipment (not shown), such as a local exchange or front-end equipment, to which telephone-network terminal TELA is then connected.

Service control point SCP comprises a connection means TRSC, a control means CPUSC, and a memory means MEMSC. It may be a server that is operated by a UNIX operating system or a Windows NT operating system. Control means CPUSC is a processor or a cluster of processors that executes the instructions of the operating system stored in memory MEMSC. Furthermore, memory means MEMSC, which comprises a hard disk or RAM modules, for example, may contain program code sequences that are executed by control means CPUSC. Control means CPUSC also influences the functions of connection means TRSC, which serves to establish the above-mentioned links VSC and VSM, for example. Service control point SCP includes further modules (not shown), for example a monitor, a keyboard, and a mouse. It may also serve further service switching points besides service switching point SSP.

Service control point SCP provides services to service switching point SSP and to further, similarly equipped switching points (not shown). Such a service is the well-known Freecall service (numbers beginning with “0800”). Service switching point SSP and service control point SCP may conform to the requirements of an intelligent network, but, according to the invention, they may also interact on link VSC in a free, proprietarily defined manner. Link VSC then extends through a local area network (LAN), for example. Such proprietary interaction can also be defined if service switching point SSP and service control point SCP are combined in a single unit. Then, memory means MEMSW additionally performs functions of memory means MEMSC, control means CPUSW performs the functions of control means CPUSC, and connection means TRSW performs the functions of connection means TRSC.

Service management point SMP controls the service functions of service control point SCP. Service management point SMP is, for example, a computer with processors and memory means as well as input and output interfaces. Via service management point SMP, new services defined for service control point SCP can be loaded into the latter over link VSM. Service management point SMP may serve further service control points (not shown) besides service control point SCP.

Of the Internet INT, only a gateway GW1 and a gateway GW2 are shown. The further infrastructure of the Internet INT, e.g., servers, routers, gateways, and the like, are not shown in FIG. 1 for the sake of simplicity. In the embodiment of FIG. 1, gateway GW1 and gateway GW2 are essentially identical in construction. Therefore, only gateway GW1 is explained in the following. Gateway GW1 comprises a connection means TRGW1, a control means CPUGW1, and a memory means MEMGW1. Gateway GW1 may be a server that is operated by a UNIX operating system, for example. Control means CPUGW1 is a processor or a cluster of processors that executes instructions of the operating system stored in memory MEMGW1. Furthermore, memory MEMGW1, which comprises a hard disk or RAM modules, for example, may contain program code sequences that are executed by control means CPUGW1. Control means CPUGW1 also influences functions of connection means TRGW1, which serves to establish a link VGW1 to service switching point SSP and a link VB1 to Internet terminal TERB, for example. Gateway GW1 includes further modules (not shown), such as a monitor, a keyboard, and a mouse. Gateway GW2 comprises a control means CPUGW2, corresponding to control means CPUGW1, a memory means MEMGW2, corresponding to memory means MEMGW1, and a connection means TRGW2, corresponding to connection means TRGW1, with which gateway GW2 can set up a link VGW2 to service switching point SSP, a link VB2 to Internet terminal TERB, and a link VSMGW to service management point SMP.

The method according to the invention will now be described with reference to FIG. 1 and to the flowchart of FIG. 2.

At step S21, telephone-network terminal TELA sends to telecommunications network PSTN a call request containing a subscriber number assigned to Internet terminal TERB. This subscriber number is entered by subscriber SUBA at telephone-network terminal TELA. The subscriber number is a conventional directory number as is also used for calls to another party connected to telecommunications network PSTN. The subscriber number may also be a UPT number assigned to subscriber SUBB. At step S22, telecommunications network PSTN routes the call request over link VA1 to service switching point SSP. The latter determines at step S23 that the call request is to be treated as a call request to an intelligent network. It may be predetermined, for example, that service switching point SSP treats each incoming call request as a call request to an intelligent network. The subscriber number specified in the call request may be preceded by a prefix by which service switching point SSP recognizes that the call request is to be handled using an IN service. At step S24, therefore, service switching point SSP transfers a service request message over link VSC to service control point SCP to request a service for handling the request for a call to the subscriber number assigned to Internet terminal TERB.

At step S25, service control point SCP determines an Internet address of the Internet terminal TERB that is assigned to the subscriber number. The Internet address is stored, for example, in a table or database stored in memory means MEMSC, which, according to the invention, may also contain further combinations of subscriber numbers and Internet addresses of further subscribers. At step S26, service control point SCP transfers a service message with the Internet address of the Internet terminal TERB to service switching point SSP.

At step S27, service switching point SSP sets up the link VGW1 to gateway GW1, using an address of gateway GW1 stored in memory means MEMSW, for example. Link VGW1 may extend through equipment and over paths of telecommunications network PSTN which are not shown in FIG. 1. At step S28, service switching point SSP sends the Internet address of Internet terminal TERB to gateway GW1, for example over a signaling link (not shown in FIG. 1) or directly over link VGW1 using in-band signaling. Using the Internet address, gateway GW1 then sets up the link VB1 to Internet terminal TERB through the Internet. The setting up of a packet-oriented link VB1 through the Internet INT using an Internet address is known per se and, therefore, need not be explained here. Telephone-network terminal TELA and Internet terminal TERB can then exchange speech data or multimedia data over the connection VA1-VGW1-VB1, for example in accordance with the H.323 definitions; gateway GW1 converts the data received from telecommunications network PSTN to the format used on the Internet INT and vice versa.

It is also possible, however, that at step S25, service control point SCP determines not only the Internet address of Internet terminal TERB, but also an address or number of gateway GW1, and that at step S26, that Internet address is sent to service switching point SSP together with that gateway address or number. As can be seen in FIG. 1, service switching point SSP can set up not only a link to gateway GW1, but also a link to gateway GW2. Then, at step S27, service switching point SSP can establish the link VGW1 or the link VGW2, depending on whether the address of gateway GW1 or that of gateway GW2 was received from service control point SCP.

The address of gateway GW1 may be stored in memory means MEMSC in association with the subscriber number and the Internet address of Internet terminal TERB. It is also possible, however, that service switching point SCP determines the address of gateway GW1 dynamically, for instance as a function of the current loading of paths for links VGW1 or VGW2. If link VGW1, for example, runs via a temporarily heavily loaded path or exchange of telecommunications network PSTN, at step S26, service control point SCP may also communicate the address of gateway GW2 to service switching point SSP, thus instructing the latter to set up the link VGW2 for telephone-network terminal TELA. It may also be more advantageous with regard to the charges incurred by the subscriber SUBA that service switching point SSP is instructed by sevice conrol point SCP to set up link VGW2 instead of VGW1.

Service control point SCP can transfer the address of gateway GW1 and the Internet address of Internet terminal TERB to service switching point SSP as separate values or as a common numerical value. To keep the amount of data to be transferred to a minimum, service control point SCP first removes the dots used in Internet addresses to separate number blocks, so that a value “149.111.111.111” becomes a value “149111111111”. Then, service control point SCP converts this numerical value from decimal to hexadecimal notation and sends it to service switching point SSP. Service switching point SSP does the reverse.

Furthermore, service control point SCP, at step S26, may send to service switching point SSP not only the address of gateway GW1, but also the address of gateway GW2, so that service switching point SSP can select whether to set up link VGW1 or link VGW2. Because of network load problems or a circuit outage, for example, it may be temporarily impossible to set up the link VGW1. Service switching point SSP can then establish the alternative link VGW2.

The Internet address of Internet terminal TERB may be stored in association with the subscriber number of subscriber SUBB in service control point SCP, for example by an operator of telecommunications network PSTN. However, such parameterization may also be performed by subscriber SUBA or subscriber SUBB, for example very conveniently if service control point SCP provides an Internet interface for parameterization which can be operated via a browser that is executed by Internet terminal TERB, for example.

Since, however, Internet terminals are commonly not connected to the Internet INT permanently, they have no permanently assigned Internet address, but an Internet address assigned per Internet session. Internet terminal TERB can then notify service control point SCP of the respective assigned Internet address using a program module stored in memory means MEMTR and executed by control means CPUTR. The highly schematic flowchart of this program module is shown in FIG. 3. The program module is, for instance, a Java applet that is loaded from service management point SMP over links VSMGW and VB2 into Internet terminal TERB.

At the beginning of an Internet session, at step S31 of the program module, Internet terminal TERB captures the Internet address temporarily assigned to Internet terminal TERB. To accomplish this, the program module can, for example, be restarted at the beginning of each Internet session or run as a background program. Step S31 will then be established as an endless loop which constantly checks whether an Internet session is in progress. Then, at step S32 of the program module, Internet terminal TERB determines its subscriber number. At step S33 of the program module, Internet terminal TERB sends a message with its currently assigned Internet address in connection with its subscriber number to service control point SCP. The message is sent over link VB2 to gateway GW2, which forwards it to service management point SMP. Service management point SMP then sends a message with the currently assigned Internet address and the subscriber number of Internet terminal TERB over link VSM to service control point SCP. Service management point SMP may also distribute the message to further service control points according to the invention in telecommunications network PSTN, which are not shown in FIG. 1. It is also possible to send the message from Internet terminal TERB to service control point SCP direct, without taking the circuitous route via service management point SMP.

In a further variant, gateway GW2 can check whether Internet terminal TERB is currently connected to the Internet INT. If that is the case, gateway GW2 can determine the Internet address currently assigned to Internet terminal TERB, for example by polling Internet channel TERB, and then send this address to service management point SMP.

Service control point SCP, as mentioned above, may also be incorporated in service switching point SSP, in gateway GW1, or in gateway GW2. Then, control means CPUGW1 or control means CPUGW2 performs the functions of control means CPUSC, memory means MEMGW1 or memory means MEMGW2 performs the functions of memory means MEMSC, and connections means TRGW1 or connection means TRGW2 performs the functions of connection means TRSC. Gateway GW1 or gateway GW2 may also be incorporated in service switching point SSP.

1. A method of establishing a connection between a telephone-network terminal (TELA), connected to a telephone network (PSTN) designed as an intelligent network, and an Internet terminal (TERB), connected to the Internet (INT), characterized by the following steps:
The telephone network (PSTN) receives from the telephone-network terminal (TELA) a request for a connection to a subscriber number assigned to the Internet terminal (TERB);
the telephone network (PSTN) routes the connection request to a service switching point (SSP);
the service switching point (SSP) determines that the connection request is to be treated as a connection request to an intelligent network;
the service switching point (SSP) transmits to a service control point (SCP) a service request message requesting a service for handling the request for the connection to the subscriber number assigned to the Internet terminal (TERB);
the service control point (SCP) determines an Internet address of the Internet terminal (TERB) assigned to the subscriber number;
the service control point (SCP) transmits to the service switching point (SSP) a service message with the Internet address of the Internet terminal (TERB);
the service switching point (SSP) establishes a connection through the telephone network (PSTN) to a (first) Internet gateway (GW1) via which the connection between the telephone-network terminal (TELA) and the Internet terminal (TERB) can be established;
the service switching point (SSP) sends the Internet address of the Internet terminal (TERB) to the (first) Internet gateway (GW1); and
the Internet gateway (GW1) establishes the link (VB1) of the connection between the telephone-network terminal (TELA) and the Internet terminal (TERB) via the Internet (INT) using the Internet address of the Internet terminal (TERB).

2. A method as claimed in claim 1, characterized in that in addition to the Internet address of the Internet terminal (TERB), the service control point (SCP) determines the address of the (first) Internet gateway (GW1), and that the service control point (SCP) transfers the address of the (first) Internet gateway (GW1) to the service switching point (SSP) for establishing the connection to the Internet gateway (GW1).

3. A method as claimed in claim 1, characterized in that the (first) Internet gateway (GW1) or the Internet terminal (TERB) transfers the Internet address of the Internet terminal (TERB) to the service control point (SCP) for storage in conjunction with the subscriber number of the Internet terminal (TERB).

4. A method as claimed in claim 1, characterized in that the service control point (SCP) determines the Internet address of the Internet terminal (TERB) from a table in which the address of the Internet terminal (TERB) is associated with a Universal Personal Telecommunications service number.

5. A method as claimed in claim 2, characterized in that the service control point (SCP) determines the address of the (first) Internet gateway (GW1) as a function of a loading of communication paths of the telephone network (PSTN) or as a function of charges incurred on the telephone network (PSTN) for the establishment of the links (VA1, VGW1) of the connection (VA1, VGW1, VB1) between the telephone-network terminal (TELA) and the Internet gateway (GW1).

6. A method as claimed in claim 2, characterized in that the service control point (SCP) determines an address of at least a second Internet gateway (GW2) and transfers the address of the first Internet gateway (GW1) and the address of the at least second Internet gateway (GW2) to the service switching point (SSP).

7. A service switching point (SSP) for establishing a connection between a telephone-network terminal (TELA), connected to a telephone network (PSTN) designed as an intelligent network, and an Internet terminal (TERB), connected to the Internet (INT), the service switching point (SSP) comprising first receiving means (TRSW) designed to enable the service switching point (SSP) to receive from the telephone-network terminal (TELA) a request for a connection to a subscriber number assigned to the Internet terminal (TERB), characterized in that the service switching point (SSP) further comprises recognition means (CPUSW) designed to enable the service switching point (SSP) to recognize that the connection request is to be treated as a connection request to an intelligent network, in that the service switching point (SSP) further comprises first sending means (TRSP) designed to enable the service switching point (SSP) to send to a service control point (SCP) a service request message requesting a service for handling the request for the connection to the subscriber number assigned to the Internet terminal (TERB), in that the service switching point (SSP) further comprises second receiving means (TRSP) designed to enable the service switching point (SSP) to receive from the service control point (SCP) a service message with the Internet address of the Internet terminal (TERB), in that the service switching point (SSP) further comprises call setup means (TRSW) designed to enable the service switching point (SSP) to set up a call through the telephone network (PSTN) to a (first) Internet gateway (GW1) via which the connection between the telephone-network terminal (TELA) and the Internet terminal (TERB) can be established, and in that the service switching point (SSP) further comprises second sending means (TRSW) designed to enable the service switching point (SSP) to send the Internet address of the Internet terminal (TERB) to the Internet gateway (GW1).

8. A service control point (SCP) for establishing a connection between a telephone-network terminal (TELA), connected to a telephone network (PSTN) designed as an intelligent network, and an Internet terminal (TERB), connected to the Internet (INT), characterized in that the service control point (SCP) comprises receiving means (TRSC) designed to enable the service control point (SCP) to receive from a service switching point (SSP) a service request message with which the service switching point (SSP) requests a service for handling a request for a connection to a subscriber number assigned to the Internet terminal (TERB), in that the service control point (SCP) further comprises means (CPUSC, MEMSC) designed to enable the service control point (SCP) to determine an Internet address of the Internet terminal (TERB) assigned to the subscriber number, and in that the service control point (SCP) further comprises sending means (TRSC) designed to enable the service control point (SCP) to send to the service switching point (SSP) a service message with the Internet address of the Internet terminal (TERB).

9. An Internet gateway (GW1) for establishing a connection between a telephone-network terminal (TELA), connected to a telephone network (PSTN) designed as an intelligent network, and an Internet terminal (TERB), connected to the Internet (INT), the Internet gateway (GW1) comprising call setup means (TRGW) designed to enable the Internet gateway (GW1) to set up a call between the telephone-network terminal (TELA) and the Internet terminal (TERB), characterized in that the Internet gateway (GW1) further comprises receiving means (TRGW1) designed to enable the Internet gateway (GW1) to receive an Internet address of an Internet terminal (TERB) from a service switching point (SSP), and that the call setup means (TRGW1) are further designed to enable the Internet gateway (GW1) to set up the connection between the telephone-network terminal (TELA) and the Internet terminal (TERB) using the Internet address of the Internet terminal (TERB).

10. A program module for an Internet terminal (TERB) for establishing a connection between a telephone-network terminal (TELA), connected to a telephone network (PSTN) designed as an intelligent network, and an Internet terminal (TERB), connected to the Internet (INT), the program module comprising program code, which can be executed by a control means of the Internet terminal (TERB), and detection means designed to enable the program module to determine that the Internet terminal (TERB) is connected to the Internet (INT) within a Internet session and which Internet address is assigned to the Internet terminal (TERB) for this session, characterized in that the program module further comprises sending means designed to enable the program module to send a message with the Internet address, together with a subscriber number assigned to the Internet terminal (TERB), to a service control point (SCP) of the telephone network (PSTN), so that the service control point (SCP) of a service switching point (SSP) can send a service message with the Internet address of the Internet terminal (TERB) when the service switching point (SSP) requests a service for handling a request for a connection to the subscriber number assigned to the Internet terminal (TERB).

11. An Internet terminal (TERB), characterized in that it comprises memory means (MEMTR) in which a program module as claimed in claim 10 is stored, and in that the Internet terminal (TERB) further comprises control means (CPUTR) designed to enable the Internet terminal (TERB) to execute program code of the program module.
